(19) United States
(12) Patent Application Publication
(10) Pub. No.: US 2007/0133706 A1
(43) Pub. Date: Jun. 14, 2007

(54) Method for correlative encoding and decoding

(76) Inventor: Char-Dir Chung, Pingjhen City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/545,568

(22) Filed: Oct. 11, 2006

(30) Foreign Application Priority Data
Dec. 14, 2005 (TW) 094144200

(51) Int. Cl. H04L 23/02

(52) U.S. Cl. 375/264

(57) ABSTRACT

A method for correlatively encoding is used to improve spectrum performance, particularly for rectangular-pulse-shaped OFDM (Orthogonal Frequency-Division Multiplexing) signals no matter whether cyclic prefix or zero padding is added to the OFDM signals or not. In accordance with the method for correlatively encoding according to the present invention, OFDM signals can achieve high spectrum efficiency. In addition, the attenuation rate of signal sidelobes in spectrum gets faster, which prevents signal power from leaking out of the bandwidth, and thereby avoids interfering with signals of adjacent channels.

### FIELD OF THE INVENTION

The present invention relates to a method for transmission of digital data, and particularly to a method for correlatively encoding and decoding in transmission of digital data.

### BACKGROUND OF THE INVENTION

In recent years, because of the advancement of information technologies, communication technologies develop rapidly as well. In various communication technologies, OFDM (Orthogonal Frequency-Division Multiplexing) technology is the most expected technology, and will be applied in the fourth-generation wireless mobile communication system. OFDM technology applies multiple-subcarrier parallel transmission, wherein the spectra of the multiple subcarriers are allowed to overlap, and each of the subcarriers maintains orthogonality to avoid interference between subcarriers.

In comparison with single-carrier modulation, OFDM owns two major features. The first feature is that OFDM has very high spectrum efficiency to use bandwidth sufficiently. Thereby, for identical data transmission rates, OFDM uses less bandwidth than single-carrier modulation. The second feature is that OFDM has the capability of resisting channel effects, which includes pulse noises, inter-symbol interference, and multi-path fading. Because OFDM has the advantages described above, it is applied in many wideband communication systems in recent years. In the majority of applications, a guard interval is used to resist bad channel effects for effective data blocks during transmission. The guard interval can be placement of cyclic prefix signals or zero padding signals. In addition, it is placed in each of transmission blocks that contain effective data. In practice, OFDM technology can be implemented by Fast Fourier Transforms. In many applications, a substantial quantity (usually hundreds) of multiplexing subcarriers is adopted to implement OFDM for taking advantage of the major features of OFDM as described above.

Although OFDM has a very high density in spectrum, and a substantial quantity of subcarriers can transmit simultaneously. However, because OFDM needs pulse shaping to extract desired signal, bad pulse shaping will make subcarriers on band edges be prone to interfering with adjacent channels. In practical application methods, the method mostly used is rectangular pulses. This method is very suitable for OFDM signals with added excess guard intervals and using Fast Fourier Transform. Unfortunately, while transmitting a substantial amount of subcarriers simultaneously, the OFDM signals shaped by rectangular pulses have considerably large energies on sidelobes in spectrum, and roll off at the rate of f⁻². In order to reduce signal distortion on band edges in channels, and to avoid energies falling into adjacent channels, in most applications, subcarriers on band edges will not be modulated. Nevertheless, this method limits the advantage of using bandwidth efficiently in OFDM. Thereby, smoother pulses are developed in a limited interval or in an unlimited interval. But the various pulse shaping cannot be adopted extensively because they cannot be implemented in Fast Fourier Transform and computational complexity is increased substantially as well.

### SUMMARY

The purpose of the present invention is to provide a method for correlatively encoding. In terms of correlatively encoded signals and then modulation to shape signal spectrum, sidelobe energies in spectrum can hardly affect signals in adjacent channels.

Another purpose of the present invention is to provide a method for correlatively decoding. In terms of correlatively decoded symbols, original data can be demodulated with precision to extract data completely.

The present invention provides a method for correlatively encoding, which is suitable for a modulation system. The method for correlatively encoding encodes data symbols [D₀ D₁ . . . D_{M-1}] of length M to transmission symbols [C₀ C₁ . . . C_{N-1}] of length N. The present method includes the following steps. First, an encoding matrix G is provides. The dimension of the encoding matrix G is N×M, and the element of the n-th row and the m-th column is g_{n,m}, wherein g_{n,m} is an encoding coefficient. Then, an encoding level L is determined. The encoding level L is a natural number. Next, the encoding level L is used to generate the encoding coefficient g_{n,m} corresponding to each element of the encoding matrix G wherein when 0<(n−m)≦L, the value of the encoding coefficient g_{n,m} is

$$( \begin{matrix}L \\ n - m\end{matrix} ) ;$$

otherwise, g_{n,m} is zero. Finally, multiply the encoding matrix G with the data symbols [D₀ D₁ . . . D_{M-1}] to get the transmission symbols [C₀ C₁ . . . C_{N-1}], wherein the length of the transmission array is N=M+L.

In accordance with the method for correlatively encoding according to a preferred embodiment of the present invention, the modulation system described above is an Orthogonal Frequency-Division Multiplexing system.

In accordance with the method for correlatively encoding according to a preferred embodiment of the present invention, when adding zero padding to the OFDM system described above, the steps described above further include multiplying the encoding coefficients g_{n,m} by an adjustment coefficient ζₙ corresponding to each row to give the value of each element of the encoding matrix G, and thus forming the encoding matrix G, wherein the encoding function ζₙ=(−1)ⁿ.

In accordance with the method for correlatively encoding according to a preferred embodiment of the present invention, when inserting cyclic prefix to the OFDM system described above, the steps described above further include multiplying the encoding coefficients g_{n,m} by an adjustment coefficient ζₙ corresponding to each row to give the value of each element of the encoding matrix G, and thus forming the encoding matrix G, wherein the encoding function ζₙ=exp{j(n/2)ω_{d}(T_{d}−T_{g}))}.

In accordance with the method for correlatively encoding according to a preferred embodiment of the present invention, when there is no guard interval in the OFDM system described above, the steps described above further include multiplying the encoding coefficients g_{n,m} by an adjustment coefficient ζₙ corresponding to each row to give the value of each element of the encoding matrix G, and thus forming the encoding matrix G, wherein the encoding function ζₙ=(−1)ⁿ.

The present invention provides a method for correlatively decoding, which is suitable for a modulation system. The method for correlatively encoding decodes received symbols {Rₙ}ₙ₌₀^{N-1} of length N to data symbols {\hat{D}ₘ}ₘ₌₀^{M-1} of length M. The present method includes the following steps.

First, provide a plurality of data symbols {Dₘ}ₘ₌₀^{M-1}, and then pass them to an encoder to generate a plurality of encoded symbols {Cₙ}ₙ₌₀^{N-1}, wherein

$${C}_{n} = {\sum }_{m = max \{ 0 , n - L \}}^{min \{ M - 1 , n \}} ( \begin{matrix}L \\ n - m\end{matrix} ) {D}_{m} ,$$

and L is an encoding level. Next, take the encoded symbols {Cₙ}ₙ₌₀^{N-1} and the received symbols {Rₙ}ₙ₌₀^{N-1} to perform the operation

$${\sum }_{n = 0}^{N - 1} {[ {R}_{n} - {C}_{n} ]}^{2} ,$$

giving a plurality of squared Euclidean distances with the same amount of the encoded symbols {Cₙ}ₙ₌₀^{N-1}. Then find a minimum squared Euclidean distance from the plurality of squared Euclidean distances. According to the minimum squared Euclidean distance, find specific encoded symbols {Cₙ}ₙ₌₀^{N-1} corresponding to the minimum squared Euclidean distance from the encoded symbols {Cₙ}ₙ₌₀^{N-1}. At last, according to the specific encoded symbols {Cₙ}ₙ₌₀^{N-1}, find specific symbols {Dₘ}ₘ₌₀^{M-1}, and take the specific symbols {Dₘ}ₘ₌₀^{M-1} as the data symbols {\hat{D}ₘ}ₘ₌₀^{M-1}.

In accordance with the method for correlatively decoding according to a preferred embodiment of the present invention, the modulation system described above is an Orthogonal Frequency-Division Multiplexing system.

In accordance with the method for correlatively decoding according to a preferred embodiment of the present invention, when adding a channel estimation module to the OFDM system described above, the steps described above further include multiplying the encoded symbols {Cₙ}ₙ₌₀^{N-1} by a channel amplitude αₙ, then perform the operation

$${\sum }_{n = 0}^{N - 1} {[ {R}_{n} - {α}_{n} {C}_{n} ]}^{2}$$

with the received symbols, and thus giving a plurality of squared Euclidean distances with the same amount of the encoded symbols.

Because the present invention adopts a method for correlatively encoding, OFDM signals can reach high spectrum efficiency. In addition, the attenuation rate of sidelobes of signals in spectrum gets faster, which prevents signal energies from leaking out of the bandwidth, and thereby avoids interfering with signals of adjacent channels.

In order to make the structure and characteristics as well as the effectiveness of the present invention to be further understood and recognized, the detailed description of the present invention is provided as follows along with preferred embodiments and accompanying figures.

### BRIEF DESCRIPTION OF THE DRAWINGS

FIG. 1 shows a system block diagram of applying correlatively encoding in a transmission side of OFDM according to a preferred embodiment of the present invention;

FIG. 2 shows spectrum efficiency curves for different N and L values for NG-OFDM signals with various [symbol] _{L} encoding and without encoding;

FIG. 3 shows spectrum efficiency curves for different T_{g}/T values for NG-OFDM, ZP-OFDM, and CP-OFDM signals with the same [symbol] ₂ encoding;

FIG. 4(a) shows flatness of NG-OFDM signals in the bandwidth without encoding and with various [symbol] _{L} encoding;

FIG. 4(b) shows flatness of CP-OFDM signals in the bandwidth without encoding and with various [symbol] _{L} encoding; and

FIG. 5 shows a system block diagram of applying correlatively decoding in a receiving side of OFDM according to a preferred embodiment of the present invention.

### DETAILED DESCRIPTION

In digital signal transmission, encoding and modulation are generally needed before transmitting signals. The reasons for applying encoding include suppressing inter-channel interference, reducing peak-to-average power ratio, and resisting channel effects. The method of correlatively encoding according to embodiments of the present invention is used for adjusting the spectrum of signals being encoded and modulated, such that sidelobes in spectrum are not prone to interfering with signals of adjacent channels. In order to describe embodiments according to the present invention, in the following, an OFDM system will be used to explain the method for correlatively encoding and decoding according to the present invention. However, it is not intended for limiting the present invention. The person skilled in the art can modify the embodiments described below according to the spirits of the present invention without departing from the scope of the present invention.

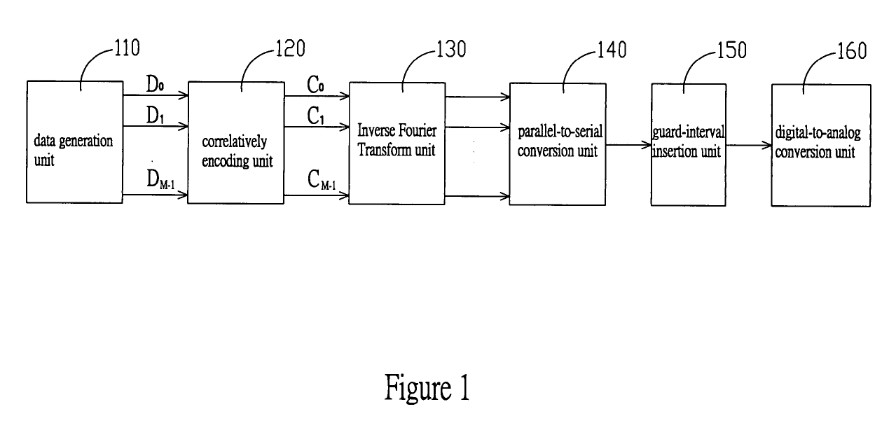

FIG. 1 shows a system block diagram of applying correlatively encoding in a transmission side of OFDM according to a preferred embodiment of the present invention. FIG. 1 includes a data generation unit 110, a correlatively encoding unit 120, an Inverse Fast Fourier Transform unit 130, a parallel-to-serial conversion unit 140, a guard-interval insertion unit 150, and a digital-to-analog conversion unit 160. The data generation unit 110 outputs data symbols. The correlatively encoding unit 120 receives the data symbols, and performs correlatively encoding on the data symbols to generate a transmission symbol. The Inverse Fast Fourier Transform unit 130 receives the transmission symbol, and performs Inverse Fourier Transform on the transmission symbol to generate a parallel data symbol. The parallel-to-serial conversion unit 140 is used to receive the parallel data symbol and generate a serial symbol. Finally, the digital-to-analog conversion unit 160 receives the serial symbol and converts it into an analog signal.

Next, the mathematical forms of practical signals with reference to FIG. 1 are used to describe the embodiments of the present invention. The data generation unit 110 generates simultaneously M independent complex data symbols {D_{m,k}}ₘ₌₀^{M-1} for every T time interval. For the k-th symbol interval, kT−T_{g}≦t<kT+T_{d}, and T=T_{d}+T_{g}, wherein T_{d} represents the time interval for transmitting effective data symbol, and T_{g} represents the time interval for adding cyclic prefix or zero padding. All D_{m,k} are assumed to be independent and to be equally distributed statistically, and have the statistical characteristics of zero mean value and E {|D_{m,k}|²}=0. First, in the k-th symbol interval, the complex data symbol {D_{m,k}}ₘ₌₀^{M-1} uses the correlatively encoding unit 120 to encode into N transmission symbols {C_{n,k}}ₙ₌₀^{N-1},

$${C}_{n , k} = {\sum }_{m = 0}^{M - 1} {G}_{n , m} {D}_{n , m} n = 0 , 1 , … , N - 1 \qquad ( 1 )$$

where G_{n,m} are complex encoding coefficients, and N≧M. The symbols output by the correlatively encoding unit 120 will be put into N parallel subcarriers, and the subcarriers are separated by an identical frequency interval ω_{d}□2π/T_{d} to form a correlatively encoded OFDM signal

$$s ( t ) = ρ {\sum }_{k} Re \{ {\sum }_{n = 0}^{N - 1} {C}_{n , k} exp \{ j ( {ω}_{0} + n {ω}_{d} ) ( t - kT ) \} \} p ( t - kT ) \qquad ( 2 )$$

where ρ is the signal amplitude, ω₀ is the reference frequency, and ω₀T□1. The window function p(t) is a pulse function, and is defined between −T_{g}≦t<T_{d}. If s(t) is formed to be an OFDM signal having cyclic prefix (abbreviated as CP-OFDM thereinafter), p(t) is a unit rectangular pulse in −T_{g}≦t<T_{d}. If s(t) is formed to be an OFDM signal having zero padding (abbreviated as ZP-OFDM thereinafter), p(t) is a unit rectangular pulse in 0≦t<T_{d}, and p(t)=0 in −T_{g}≦t<0. In Equation (2), the signal format is interpreted as an N-point Inverse Fast Fourier Transform (IFFT) structure, and thereby the Inverse Fast Fourier Transform unit 130 is as shown in FIG. 1. Accordingly, the relation between the time length Tₛ of the data symbols and the time length T of the whole block is as Tₛ=T/M.

Using Equation (1), s(t) can be rewritten as

$$s ( t ) = ρ {\sum }_{m = 0}^{M - 1} {\sum }_{k} Re \{ {D}_{m , k} {q}_{m} ( t - kT ) \} \qquad ( 3 )$$

where qₘ(t) is independent of data, and is defined as

$${q}_{m} ( t ) • {\sum }_{n = 0}^{N - 1} {G}_{n , m} exp \{ j ( {ω}_{0} + n {ω}_{d} ) t \} p ( t ) .$$

By Equation (3), it can be observed that s(t) is a multiplexing signal formed by M independent signal components, and the M independent signal components have the statistical characteristic of zero mean value. Besides, each signal component is loaded with a data stream without memory. If we cross the format of each signal component displaced by lT to {D_{m,k}}ₘ₌₀^{M-1} loaded by M signal components, the Power Spectral Density (PSD) of s(t) is given for a specific k. When k=0, the PSD of s(t) is given by

$$S ( f ) = \frac{{ρ}^{2}}{4 T} {{\sum }^{M - 1}}_{m = 0} ɛ \{ {\vert {D}_{m , 0} F \{ {q}_{m} ( t ) \} + {D}_{m , 0}^{*} F \{ {q}_{m}^{*} ( t ) \} \vert}^{2} \} \qquad ( 4 )$$

where ε}•} and F{•} represent expectation value and Fourier Transform, respectively. Because ω₀T□1, in practice, F{qₘ(t)} and F{q*ₘ(t)} can be decomposed into positive and negative spectrum components, respectively. Equation (4) can be simplified as

$$S ( f ) = \frac{{ρ}^{2}}{4 T} {\sum }_{m = 0}^{M - 1} \{ {\vert F \{ {q}_{m} ( t ) \} \vert}^{2} + {\vert F \{ {q}_{m}^{*} ( t ) \} \vert}^{2} \} \qquad ( 5 )$$

And the equivalent low-pass PSD can be expressed as

$$\begin{matrix}{S}_{LP}^{CP} ( f ) = \frac{{ρ}^{2} T}{2} {\sum }_{m = 0}^{M - 1} {\vert {\sum }_{n = 0}^{N - 1} {g}_{n , m} sin c ( ( n - \frac{N - 1}{2} ) \frac{T}{{T}_{d}} - fT ) \vert}^{2} & ( 6 ) \\ {S}_{LP}^{ZP} ( f ) = \frac{{ρ}^{2} {T}_{d}^{2}}{2} {\sum }_{m = 0}^{M - 1} {\vert {\sum }_{n = 0}^{N - 1} {g}_{n , m} sin c ( n - \frac{N - 1}{2} - {fT}_{d} ) \vert}^{2} & ( 7 )\end{matrix}$$

where S_{LP}^{CP}(f) is the PSD of CP-OFDM, and S_{LP}^{ZP}(f) is the PSD of ZP-OFDM. Here, sinc(x) is a sampling function, and is defined as sinc(x)□ sin(πx)/(πx). In addition, g_{n,m} is correlated to G_{n,m}, and the correlation is g_{n,m} □ ζₙG_{n,m}.

For CP-OFDM, ζₙ=exp{j(n/2)ω_{d}(T_{d}−T_{g})}; and for ZP-OFDM, ζₙ=(−1)ⁿ. Besides, the power transmitted by CP-OFDM is

$$P = \frac{{ρ}^{2}}{2} {\sum }_{m = 0}^{M - 1} {\sum }_{n = 0}^{N - 1} {\sum }_{l = 0}^{N - 1} {g}_{n . m} {g}_{l , m}^{*} sin c ( ( n - l ) \frac{T}{{T}_{d}} ) ;$$

and the power transmitted by ZP-OFDM is

$$P = \frac{{ρ}^{2} {T}_{d}}{2 T} {\sum }_{m = 0}^{M - 1} {\sum }_{n = 0}^{N - 1} {\vert {g}_{n , m} \vert}^{2} .$$

When T_{g}=0, the signals of CP-OFDM and ZP-OFDM are both converted into OFDM signals without guard intervals (abbreviated a NG-OFDM thereinafter). And the equivalent low-pass PSD can be expressed as

$${S}_{LP}^{NG} ( f ) = \frac{PT}{{\sum }_{m = 0}^{M - 1} {\sum }_{n = 0}^{N - 1} {\vert {g}_{n , m} \vert}^{2}} {\sum }_{m = 0}^{M - 1} {\vert {\sum }_{n = 0}^{N - 1} {g}_{n , m} U ( \frac{N - 1}{2} + fT ; 0 , n ) \vert}^{2} \qquad ( 8 )$$

where g_{n,m}=ζₙG_{n,m}, and ζₙ=(−1)ⁿ. For convenience, U(x;0,n) is used to represent the sampling function. That is, U(x;0,n)=sinc(n−x), n=0, 1, . . . .

According to an embodiment of the present invention, a special correlative code is adopted, which features that when n∉ {m,m+1, . . . ,m+L}, G_{n,m}=0, and L is set as L=N−M. By Equation (1), such a correlative encoder uses convolution of a data symbol block {D_{m,k}}ₘ₌₀^{M-1} and a complex response with a finite length {G_{m+1,m};l=0, 1, . . . , L}ₘ₌₀^{M-1} to generate a transmission symbol block {C_{n,k}}ₙ₌₀^{N-1}. In addition, the correlative encoder can be regarded a complex filter in frequency domain. Specifically, there are various types of filers to be chosen from. We can find out a most ideal complex response for complying with the rules in signal spectrum. Thereby, in the following, a special correlative code provided by an embodiment of the present invention will be described.

The correlative code is expressed as g_{n,m}=\tilde{g}ₙ₋ₘ for all n and m, and \tilde{g}_{n,m} is defined as

$${\tilde{g}}_{l} = ( \begin{matrix}L \\ l\end{matrix} )$$

for l=0, 1, . . . , L, and as \tilde{g}ₗ=0 otherwise. In Equations (6), (7), and (8), it can be pointed out clearly that when L=0, the signal in Equation (2) is simplified to an unencoded rectangularly-pulsed OFDM signal, and the sidelobes thereof in power spectrum roll off at the rate of f⁻². When L is a positive integer, for convenience, [symbol] _{L} is used to represent the correlative code {\tilde{g}ₗ}ₗ₌₀^{L-1} with L level.

Next, in order to describe succinctly the [symbol] _{L} correlative code according to the present invention, the data symbol is expressed by [D₀ D₁ . . . D_{M-1}] and the transmission symbol is expressed by [C₀ C₁ . . . C_{N-1}], and the method for correlatively encoding can be induced into the following steps: First, an encoding matrix G is provides. The dimension of the encoding matrix G is N×M, and the element of the n-th row and the m-th column is g_{n,m}, wherein the g_{n,m} is an encoding coefficient. Then, an encoding level L is determined. The encoding level L is a natural number. Next, the encoding level L is used to generate the encoding coefficients g_{n,m} corresponding to each element of the encoding matrix G, wherein when 0<(n−m)≦L, the value of the encoding coefficients g_{n,m} is

$$( \begin{matrix}L \\ n - m\end{matrix} ) ;$$

otherwise, it is zero. Finally, multiply the encoding matrix G with the data symbols [D₀ D₁ . . . D_{M-1}] to get the transmission symbols [C₀ C₁ . . . C_{N-1}], wherein the length of the transmission array is N=M+L.

In order to have better performance, when applying the method for correlatively encoding according to the present invention to an OFDM system, the steps described above further include multiplying the encoding coefficients g_{n,m} by an adjustment coefficient ζₙ corresponding to each row to give the value of each element of the encoding matrix G, and thus forming the encoding matrix G. When the OFDM system is a CP-OFDM, the encoding function is ζₙ=exp{j(n/2)ω_{d}(T_{d}−T_{g})}. When the OFDM system is a ZP-OFDM or NG-OFDM, the encoding function is ζₙ=(−1)ⁿ.

In order to prove that correlatively encoding [symbol] _{L} can achieve advantages in spectrum, a new function set, which is configured to include U(x;0,n), will be introduced as follows.

A) The new function set {U(x;m,n);m,n=0, 1, . . . }: For all real numbers x and non-negative integers m and n, a real function U(x;m,n) is defined as

$$U ( x ; m , n ) • {π}^{- 1} m ! sin ( π ( n - x ) ) {\prod }_{k = 0}^{m} {{( n + k - x )}^{- 1} }_{∘} \qquad ( 9 )$$

The function set {U(x;m,n);m,n=0, 1, . . . } satisfies the following features:

Feature 1: When x and n are fixed, U(x;m,n) satisfies a recursive equation
U(x;m,n)=U(x;m−1,n)+U(x;m−1,n+1) m=1, 2, . . .

Feature 2: When x and n are fixed, U(x;m,n) is a linear combination of U(x;0,n+l) l=0, 1, . . . ,m, then U(x;m,n) can expressed as

$$U ( x ; m , n ) = {\sum }_{l = 0}^{m} ( \begin{matrix}m \\ l\end{matrix} ) U ( x ; 0 , n + l ) , \qquad m = 1 , 2 , …$$

Feature 3: If m and n are finite values, when |x| approaches infinity, changes of the values of U²(x;m,n) are proportional to changes of the values of x^{-2(m+1)}.

where, based on Equation (9), Feature 1 can be proved rapidly using induction, and according to the definition of Equation (9), Feature 1 can then be used to induce Feature 2 and Feature 3.

B) The frequency characteristics and performance of OFDM signals with [symbol] _{L} encoding: After using z,900 _{L} encoding, Equation (8) becomes

$$\begin{matrix}{S}_{LP}^{NG} ( f ) = \frac{PT}{M {\sum }_{l = 0}^{L} {( \begin{matrix}L \\ l\end{matrix} )}^{2}} {\sum }_{m = 0}^{M - 1} {\vert {\sum }_{l = 0}^{L} ( \begin{matrix}L \\ l\end{matrix} ) U ( \frac{N - 1}{2} + fT ; 0 , m + l ) \vert}^{2} \\ = \frac{PT}{M ( \begin{matrix}2 L \\ L\end{matrix} )} {\sum }_{m = 0}^{M - 1} {U}^{2} ( \frac{N - 1}{2} + fT ; L , m )\end{matrix} \qquad ( 10 )$$

The second equal sign in Equation (10) is derived from Feature 2 and the formula

$${\sum }_{l = 0}^{L} {( \begin{matrix}L \\ l\end{matrix} )}^{2} = ( \begin{matrix}2 L \\ L\end{matrix} ) .$$

When M, N, and L are finite values, it can be observed from Feature 3 that when |fT| approaches infinity, S_{LP}^{NG}(f) changes at |fT|^{-2(L+1)}.This implies that the sidelobes of NG-OFDM signals with [symbol] _{L} encoding in spectrum have faster rolloffs. Thereby, NG-OFDM signals with [symbol] _{L} encoding, in comparison with general unencoded OFDM signals, are expected to have better frequency density, thus enhancing spectrum efficiency (particularly when L is large). Because in Equation (10), T_{d} replaces T in S_{LP}^{ZP}(f) to form a precise format, thereby the same explanation can be also applied to ZP-OFDM signals with [symbol] _{L} encoding.

The density of spectrum described above can be observed from power ratio outside of band

$$η = 10 {log}_{10} ( 1 - \frac{1}{P} {\int }_{- B / 2}^{B / 2} {S}_{LP} ( f ) ⅆ f ) \qquad ( 11 )$$

where η represents the ratio of power outside of the band [−B/2,B/2] to total power. In particular, for different signals, the spectrum thereof as a function of η will be studied with a standardized bandwidth BTₛ, so that spectrum efficiency of said different signals can be compared at the same data symbol rate. Here, spectrum efficiency means the reciprocal of BTₛ required to achieve a fixed η. Hence, in order to achieve the same η, signals need smaller BTₛ to attain higher spectrum efficiency.

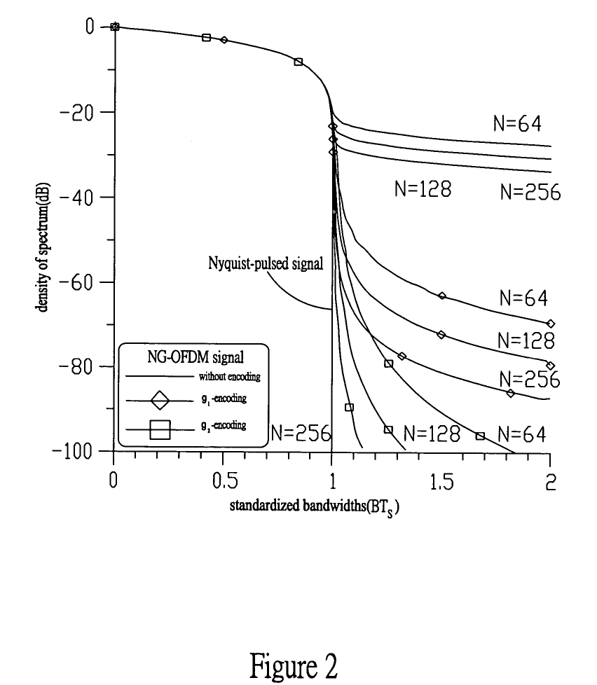

FIG. 2 shows spectrum efficiency curves for different N and L values for NG-OFDM signals with various [symbol] _{L} encoding and without encoding. The ideal performance of a single-carrier Nyquist-pulsed signal will be a baseline, and is put in FIG. 2 for comparison. The ideal performance thereof is that when |f|<1/(2Tₛ), S_{LP}(f)=Tₛ; otherwise, S_{LP}(f)=0. When η is very small (less than −20 dB), under achievable spectrum frequency, many trends will be observed. First, the spectrum efficiency of encoded and unencoded NG-OFDM signals, as shown in FIG. 2, improve with an increase of N. Such an improvement is minor for unencoded NG-OFDM signals. However, it is significant for the spectrum efficiency of NG-OFDM signals with [symbol] _{L} encoding. Secondly, when N is fixed, in comparison with NG-OFDM signals without [symbol] _{L} encoding, NG-OFDM signals with [symbol] _{L} encoding improve spectrum efficiency substantially. Such a significant change can be easily observed when merely using [symbol] ₁ encoding. In addition, when the level of encoding is increased, the spectrum efficiency will be improved significantly as well. Thirdly, NG-OFDM signals with [symbol] _{L} encoding can provide high spectrum efficiency even when needed η is very small. For example, if η is required to be η=−80 dB, for N=256, the standardized bandwidths BTₛ of [symbol] ₁-encoded and [symbol] ₂-encoded NG-OFDM signals are 1.44 and 1.05, respectively. On the other hand, for unencoded NG-OFDM signals, the standardized bandwidth BTₛ thereof is very large, and thereby is unfeasible in practice. Finally, it is observed by FIG. 2 that for N=256, the performance of [symbol] ₂-encoded NG-OFDM signals is already very close to Nyquist performance. Even when the required η is very small, its performance is also very close to ideal Nyquist performance.

For ZP-OFDM, by observing Equation (7), when [symbol] _{L}, M, N, and T are fixed, the relation between S_{LP,1}^{ZP}(f) of ZP-OFDM using T_{d,1} and S_{ZP,2}^{ZP}(f) of ZP-OFDM using T_{d,2} is S_{LP,1}^{ZP}(f)(f/T_{d,1})/T_{d,1}=S_{LP,2}^{ZP}(f)(f/T_{d,2})/T_{d,2}. Applying this relation to Equation (11), it shows that a ZP-OFDM signal using T_{d} has (T_{d}/T) times of spectrum efficiency over a NG-OFDM signal. Thereby, multiplying the results in FIG. 2 by a T_{d}/T factor gives the spectrum efficiency of ZP-OFDM.

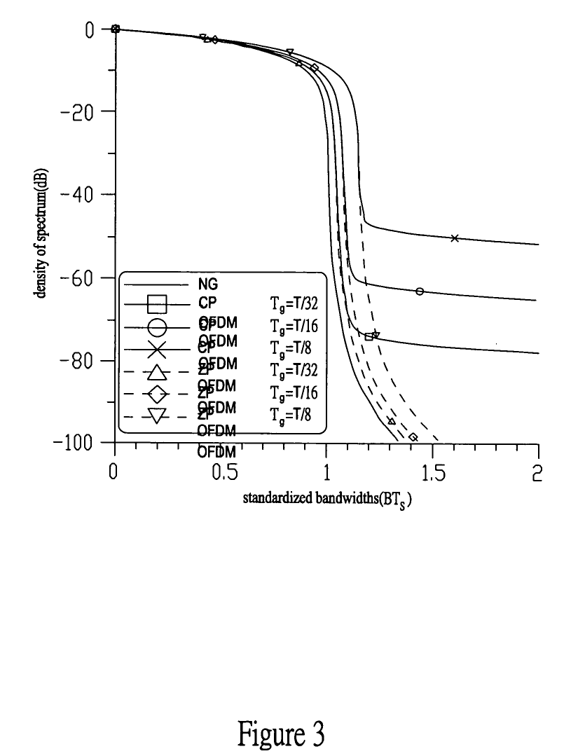

Because of using a guard interval, ZP-OFDM and CP-OFDM will reduce the spectrum efficiency of NG-OFDM. In addition, the longer the guard interval, the more seriously the spectrum efficiency will be reduced. FIG. 3 shows spectrum efficiency curves for different T_{g}/T values for NG-OFDM, ZP-OFDM, and CP-OFDM signals with the same [symbol] ₂ encoding. By FIG. 3, it is observed that when η is required to be η=−80 dB, for the same T_{g}/T, the performance of ZP-OFDM is superior to CP-OFDM. Even though T_{g}/T is as high as ⅛, ZP-OFDM and CP-OFDM with [symbol] ₂ encoding, which are inferior to NG-OFDM in spectrum efficiency, can still achieve η=−40 dB.

Because for every T time interval, M data symbols of N subcarriers are transmitted, the data transmission rate provided by [symbol] _{L}-encoded OFDM is T_{g}/T times to that provided by unencoded OFDM. However, such a loss is negligible when N □ L. When the power demand outside of band is small, even though [symbol] _{L}-encoded OFDM has losses in data transmission rate, it still provide higher efficiency than unencoded OFDM.

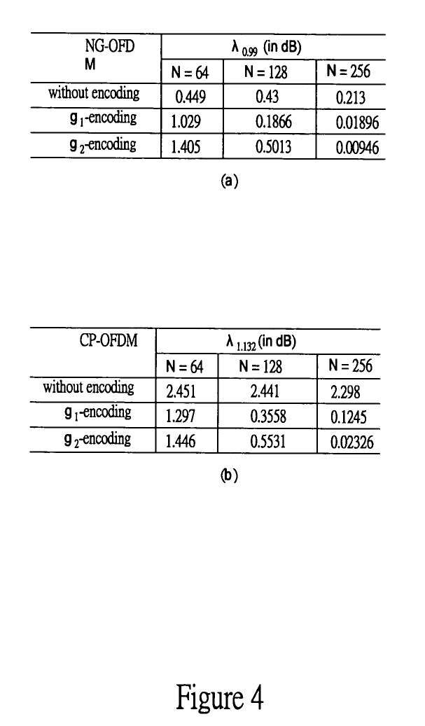

Here, a new number λₓ is defined as the ratio of maximum to minimum PSD in a normalized bandwidth X. That is, λ_{X} □ max_{|f|≦X/(2T}_{ₛ}₎ S_{LP}(f)/min_{|f|≦X/(2T}_{ₛ}₎ S_{LP}(f). Thereby, this number λ_{X} represents flatness of signals in spectrum in the bandwidth. FIG. 4(a) shows flatness of NG-OFDM signals in the bandwidth without encoding and with various [symbol] _{L} encoding; FIG. 4(b) shows flatness of CP-OFDM signals in the bandwidth without encoding and with various [symbol] _{L} encoding. By FIGS. 4(a) and 4(b), when N is large enough, [symbol] _{L}-encoded signals in the bandwidth are flatter in spectrum than unencoded signals.

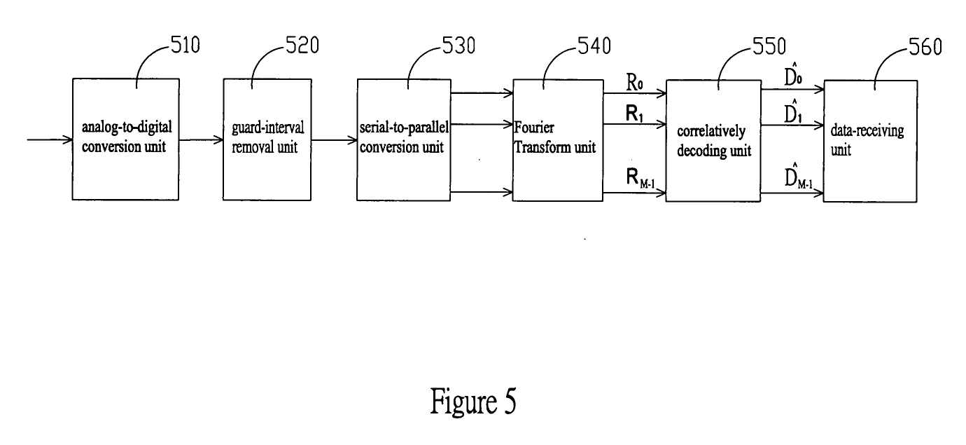

FIG. 5 shows a system block diagram of applying correlatively decoding in a receiving side of OFDM according to a preferred embodiment of the present invention. FIG. 5 includes an analog-to-digital conversion unit 510, a guard-interval removal unit 520, a serial-to-parallel conversion unit 530, a Fourier Transform unit 540, a correlatively decoding unit 550, and a data-receiving unit 560. The analog-to-digital conversion unit 510 receives an analog signal, and converts it to a digital signal. After the guard-interval removal unit 520 removes excess guard intervals from the digital signal, the serial-to-parallel conversion unit 530 then converts it to a parallel symbol. Next, the Fast Fourier Transform unit 540 performs Fast Fourier Transform to the parallel symbol, which is then decoded to original data symbols by the correlatively decoding unit 550. Finally, the data symbols are output to the data-receiving unit 560.

At the receiving side, the receiver is assumed synchronous perfectly with the amplitude, frequency, phase, and timing of the received signals. By using the Maximum Likelihood (ML) method, the received useful [symbol] _{L}-encoded OFDM signal blocks can be decoded coherently. In order to take the method for correlatively decoding according to the present invention for example, consider the [symbol] _{L}-encoded OFDM signals have the modulation components of Quadrature Amplitude Modulation (QAM). In addition, ML coherent decoding method is used, and the real part (I) and the imaginary part (Q) of the channel components can be operated separately.

At the k-th symbol interval at the receiving side, {R_{n,k}^{(x)}}ₙ₌₀^{N-1} are used to represent the symbols passed through channel x and output by FFT module, wherein x=I and Q, and R_{n,k}^{(x)} is the real symbol received by the n-th subcarrier and is defined as R_{n,k}^{(x)}=αₙC_{n,k}^{(x)}+W_{n,k}^{(x)}. Here, {C_{n,k}^{(x)}}ₙ₌₀^{N-1} are symbol blocks given by [symbol] _{L}-encoding {D_{m,k}^{(x)}}ₘ₌₀^{M-1}, where {D_{m,k}^{(x)}}ₘ₌₀^{M-1} are data symbols after pulse amplitude modulation (PAM), and D_{n,k}^{(x)} ε {±β, ±3β, . . . , ±(J−1)β}. The [symbol] _{L}-encoded symbols are

$${C}_{n , k}^{( x )} = {\sum }_{m = max \{ 0 , n - L \}}^{min \{ M - 1 , n \}} ( \begin{matrix}L \\ n - m\end{matrix} ) {D}_{m , k}^{( x )} .$$

αₙ is the channel amplitude of the n-th subcarrier. {W_{n,k}^{(x)}}ₙ₌₀^{N-1} are the samples of Additive White Gaussian Noise (AWGN), and have the feature of being independent and being distributed evenly over different channels and subcarriers. In addition, it also has the statistical characteristic of zero mean value. Based on {R_{n,k}^{(x)}}ₙ₌₀^{N-1}, use ML decoding block rules to find out {\hat{D}_{m,k}^{(x)}}ₘ₌₀^{M-1}, which generate minimum squared Euclidean distance.

$${\{ {\hat{D}}_{m , k}^{( x )} \}}_{m = 0}^{M - 1} {min}_{{\{ {D}_{m , k}^{( x )} \}}_{m = 0}^{M - 1}} {\sum }_{n}^{N - 1} {{[ {R}_{n , k}^{( x )} - {α}_{n} {\sum }_{m = max \{ 0 , n - L \}}^{min \{ M - 1 , n \}} ( \begin{matrix}L \\ n - m\end{matrix} ) {D}_{m , k}^{( x )} ]}^{2} }_{∘} \qquad ( 12 )$$

Equation (12) is a most ideal rule, which means that minimum error rate for each data block after coherent decoding can be achieved.

In the following, a specific decoding method will be used to implement Equation (12). The fast-Fourier transformed received symbols, simply expressed by {Rₙ}ₙ₌₀^{N-1}, are decoded to data symbols {\hat{D}ₘ}ₘ₌₀^{M-1}. The present decoding method includes the following steps. First, provide a plurality of data symbols {Dₘ}ₘ₌₀^{M-1}, and then pass them to an encoder to generate a plurality of encoded symbols {Cₙ}ₙ₌₀^{N-1}, wherein

$${C}_{n} = {\sum }_{m = max \{ 0 , n - L \}}^{min \{ M - 1 , n \}} ( \begin{matrix}L \\ n - m\end{matrix} ) {D}_{m} ,$$

and L is an encoding level. Next, take the encoded symbols {Cₙ}ₙ₌₀^{N-1} and the received symbols {Rₙ}ₙ₌₀^{N-1} to perform the operation

$${\sum }_{n = 0}^{N - 1} {[ {R}_{n} - {C}_{n} ]}^{2} ,$$

giving a plurality of squared Euclidean distances with the same amount of the encoded symbols {Cₙ}ₙ₌₀^{N-1}. Then find a minimum squared Euclidean distance from the plurality of squared Euclidean distances. According to the minimum squared Euclidean distance, find specific encoded symbols {Cₙ}ₙ₌₀^{N-1} corresponding to the minimum squared Euclidean distance from the encoded symbols {Cₙ}ₙ₌₀^{N-1} described above. The specific encoded symbols {Cₙ}ₙ₌₀^{N-1} will correspond to specific symbols {Dₘ}ₘ₌₀^{M-1}, which will be used as the decoded data symbols {\hat{D}ₘ}ₘ₌₀^{M-1}. When adding a channel estimation module to the OFDM receiving side, the steps described above further include multiplying the encoded symbols {Cₙ}ₙ₌₀^{N-1} by a channel amplitude αₙ, then perform the operation

$${\sum }_{n = 0}^{N - 1} {[ {R}_{n} - {α}_{n} {C}_{n} ]}^{2}$$

with the received symbols, and thus giving a plurality of squared Euclidean distances with the same amount of the encoded symbols.

Because in Equation (12), the distances of the matrix are squared and summed in terms of the subscript n, the decoding rule provided by Equation (12) can be implemented effectively by Viterbi algorithm. Viterbi algorithm can progressively calculate the squared distances in terms of the subscript n, and can find the minimum squared Euclidean distance rapidly. Thereby, {\hat{D}ₘ}ₘ₌₀^{M-1} are decoded.

To sum up, the original rectangular-pulse-shaped OFDM signals have considerably large energies on sidelobes in spectrum and roll off at the rate of f⁻². On the other hand, the sidelobes of the [symbol] _{L}-encoded OFDM signals roll off at the rate of f^{-2(L+1)}. Accordingly, energies of the [symbol] _{L}-encoded OFDM signals are more less possible to leaking out of the bandwidth, which in turn prevents interfering with signals of adjacent channels. In addition, it also makes the [symbol] _{L}-encoded OFDM signals achieve very high spectrum efficiency. Furthermore, the person skilled in the art should know that because power of OFDM signals leaking out of the bandwidth is improved, in practical signal transmission, error rate can be reduced and thus increasing efficiency of the whole system.

However, the person skilled in the art should know that the method for correlatively encoding and decoding according to the present invention is not limited to OFDM systems. The method according to the present invention is still applicable to various modulation systems, for example, orthogonally-multiplexed orthogonal amplitude modulation (OMOAM) systems, to improve spectrum of transmitted signals.

Accordingly, the present invention conforms to the legal requirements owing to its novelty, unobviousness, and utility. However, the foregoing description is only a preferred embodiment of the present invention, not used to limit the scope and range of the present invention. Those equivalent changes or modifications made according to the shape, structure, feature, or spirit described in the claims of the present invention are included in the appended claims of the present invention.

1. A method for correlatively encoding, which is suitable for a modulation system and encodes data symbols [D₀ D₁ . . . D_{M-1}] of length M to transmission symbols [C₀ C₁ . . . C_{N-1}] of length N, comprising the steps of:
providing an encoding matrix G, the dimension thereof being N×M, and the element of the n-th row and the m-th column being g_{n,m}, wherein g_{n,m} is an encoding coefficient;
determining an encoding level L, the encoding level L being a natural number;
using the encoding level L to generate the encoding coefficient g_{n,m} corresponding to each element of the encoding matrix G, wherein when 0<(n−m)≦L, the value of the encoding coefficient g_{n,m} is
$$( \begin{matrix}L \\ n - m\end{matrix} ) ;$$
otherwise, g_{n,m} is zero; and
multiplying the encoding matrix G with the data symbols [D₀ D₁ . . . D_{M-1}] to get the transmission symbols [C₀ C₁ . . . C_{N-1}], wherein the length of the transmission array is N=M+L.

2. The method for correlatively encoding of claim 1, wherein the modulation system is an Orthogonal Frequency-Division Multiplexing system.

3. The method for correlatively encoding of claim 2, and when adding zero padding to the Orthogonal Frequency-Division Multiplexing system, further comprising the step of:
multiplying the encoding coefficients g_{n,m} by an adjustment coefficient ζₙ corresponding to each row to give the value of each element of the encoding matrix G, and thus forming the encoding matrix G, wherein the encoding function ζₙ=(−1)ⁿ.

4. The method for correlatively encoding of claim 2, and when adding cyclic prefix to the Orthogonal Frequency-Division Multiplexing system, further comprising the step of:
multiplying the encoding coefficients g_{n,m} by an adjustment coefficient ζₙ corresponding to each row to give the value of each element of the encoding matrix G, and thus forming the encoding matrix G, wherein the encoding function ζₙ=exp{j(n/2)ω_{d}(T_{d}−T_{g})}.

5. The method for correlatively encoding of claim 2, and when there is no guard interval in the Orthogonal Frequency-Division Multiplexing system, further comprising the step of:
multiplying the encoding coefficients g_{n,m} by an adjustment coefficient ζₙ corresponding to each row to give the value of each element of the encoding matrix G, and thus forming the encoding matrix G, wherein the encoding function ζₙ=(−1)ⁿ.

6. The method for correlatively encoding of claim 1, wherein the modulation system is an Orthogonally-Multiplexed Orthogonal Amplitude Modulation (OMOAM) system.

7. A method for correlatively decoding, which is suitable for a modulation system and decodes received symbols {Rₙ}ₙ₌₀^{N-1} of length N to data symbols {\hat{D}ₘ}ₘ₌₀^{M-1} of length M, comprising the steps of:
a. providing a plurality of data symbols {Dₘ}ₘ₌₀^{M-1};
b. passing data symbols {Dₘ}ₘ₌₀^{M-1} to an encoder, generating a plurality of encoded symbols {Cₙ}ₙ₌₀^{N-1}, wherein
$${C}_{n} = {\sum }_{m = max \{ 0 , n - L \}}^{min \{ M - 1 , n \}} ( \begin{matrix}L \\ n - m\end{matrix} ) {D}_{m} ,$$
and L is an encoding level;
c. performing the operation
$${\sum }_{n = 0}^{N - 1} {[ {R}_{n} - {C}_{n} ]}^{2}$$
to the encoded symbols {Cₙ}ₙ₌₀^{N-1} and the received symbols {Rₙ}ₙ₌₀^{N-1}, giving a plurality of squared Euclidean distances with the same amount of the encoded symbols {Cₙ}ₙ₌₀^{N-1};
d. finding a minimum squared Euclidean distance from the plurality of squared Euclidean distances;
e. finding specific encoded symbols {Cₙ}ₙ₌₀^{N-1} corresponding to the minimum squared Euclidean distance from the encoded symbols {Cₙ}ₙ₌₀^{N-1} according to the minimum squared Euclidean distance;
f. finding specific symbols {Dₘ}ₘ₌₀^{M-1} according to the specific encoded symbols {Cₙ}ₙ₌₀^{N-1}; and
g. taking the specific symbols {Dₘ}ₘ₌₀^{M-1} as the data symbols {\hat{D}ₘ}ₘ₌₀^{M-1}.

8. The method for correlatively decoding of claim 7, wherein the modulation system is an Orthogonal Frequency-Division Multiplexing system.

9. The method for correlatively decoding of claim 7, wherein the steps c-f use a Viterbi algorithm to decode the data symbols {\hat{D}ₘ}ₘ₌₀^{M-1}.

10. The method for correlatively decoding of claim 7, and when adding a channel estimation module to the modulation system, further comprising the step of:
multiplying the encoded symbols {Cₙ}ₙ₌₀^{N-1} by a channel amplitude αₙ and then performing the operation
$${\sum }_{n = 0}^{N - 1} {[ {R}_{n} - {α}_{n} {C}_{n} ]}^{2}$$
with the received symbols, and thus giving a plurality of squared Euclidean distances with the same amount of the encoded symbols.

11. The method for correlatively decoding of claim 7, wherein the modulation system is an Orthogonally-Multiplexed Orthogonal Amplitude Modulation (OMOAM) system.
